(19) United States
(12) Patent Application Publication
(10) Pub. No.: US 2015/0147479 A1
(43) Pub. Date: May 28, 2015

(54) METHODS FOR THE FORMATION OF COOLING CHANNELS, AND RELATED ARTICLES OF MANUFACTURE

(71) Applicant: General Electric Company, Schenectady, NY (US)

(72) Inventors: Ronald Scott Bunker, West Chester, OH (US); Luc Stephane Leblanc, Clifton Park, NY (US); Leonardo Ajdelsztajn, Niskayuna, NY (US)

(73) Assignee: General Electric Company, Schenectady, NY (US)

(21) Appl. No.: 14/087,897

(22) Filed: Nov. 22, 2013

(51) Int. Cl. C23C 4/00; C23C 4/12; C23C 4/08; F01D 25/14; F01D 5/18

(52) U.S. Cl. CPC C23C 4/005; F01D 25/14; F01D 5/186; C23C 4/085; C23C 4/127; F05D 2230/90; F05D 2300/173; F05D 2230/31; F05D 2260/204
USPC 427/448; 427/265

(57) ABSTRACT

A method for the formation of channels on a metallic substrate is described. The method includes the steps of applying at least one layer of a metallic coating material onto a surface of the substrate by a cold spray technique, so as to define boundary walls for the channels, and to build the boundary walls to a desired height. Additional coating material is then applied on one or more surfaces of the boundary walls by the cold spray technique, so as to modify the shape of the channels. The substrate can be any type of high-temperature component or hot gas path component. In some instances, the substrate is a gas turbine engine wall.

### BACKGROUND

The general subject matter of this invention relates to gas turbine engines, and, more specifically, to structures for cooling various components of the engines.

A gas turbine engine includes a compressor, in which engine air is pressurized. The engine also includes a combustor, in which the pressurized air is mixed with fuel, to generate hot combustion gases. In a typical design (e.g., for aircraft engines or stationary power systems), energy is extracted from the gases in a high pressure turbine (HPT) which powers the compressor, and in a low pressure turbine (LPT). The low pressure turbine powers a fan in a turbofan aircraft engine application, or powers an external shaft for marine and industrial applications.

The need for cooling systems in gas turbine engines is critical, since the engines usually operate in extremely hot environments. For example, the engine components are often exposed to hot gases having temperatures up to about 3800° F. (2093° C.), for aircraft applications, and up to about 2700° F. (1482° C.), for the stationary power generation applications. To cool the components exposed to the hot gases, these “hot gas path” components typically have both internal convection and external film cooling.

Many aspects of cooling circuits and features in various hot gas path components have been described in the art. For example, the combustor includes radially outer and inner liners, which require cooling during operation. Turbine nozzles include hollow vanes supported between outer and inner bands, which also require cooling. Turbine rotor blades are hollow and typically include cooling circuits therein, with the blades being surrounded by turbine shrouds, which also require cooling. The hot combustion gases are discharged through an exhaust which may also be lined, and suitably cooled.

In all of these exemplary gas turbine engine components, thin metal walls of high strength superalloy metals are typically used for enhanced durability, while minimizing the need for cooling thereof. Various cooling circuits and features are tailored for these individual components in their corresponding environments in the engine. For example, a series of internal cooling passages, or serpentine channels, may be formed in a hot gas path component. A cooling fluid may be provided to the serpentines from a plenum, and the cooling fluid may flow through the passages, cooling the hot gas path component substrate and coatings. While this type of cooling design may be effective in some cases, its use in other situations may result in comparatively low heat transfer rates and non-uniform component temperature profiles.

Micro-channel cooling (as the feature is explained below) has the potential to significantly reduce cooling requirements by placing the cooling as close as possible to the heat zone, thus reducing the temperature difference between the hot side and cold side for a given heat transfer rate. However, current techniques for forming microchannels typically require the use of a sacrificial filler to keep the coating from being deposited within the microchannels (which usually need to be formed by machining) The sacrificial filler also supports the coating during deposition.

In carrying out these types of techniques, the filling of the channels with a fugitive material, as well as the subsequent removal of that material, present potential problems for current micro-channel processing techniques. For example, the filler must be compatible with the substrate and coatings, yet have minimal shrinkage, but also have sufficient strength. Removal of the sacrificial filler involves potentially damaging processes of leaching, etching, or vaporization, and typically requires long times. Residual filler material is also a concern.

To address some of these concerns, more advanced techniques have been developed recently, e.g., additive processes in which channels are generally formed on top of the selected surface of a part. U.S. patent application Ser. 13/826,115, filed Mar. 14, 2013 (R. Bunker et al) describes the use of direct metal laser melting (DMLM) or a laser engineered net shape (LENS) process, to form three-dimensional channel structures. These techniques can be very useful for precisely forming the channels and other openings and features, on or within a substrate.

For many applications, the precision of DMLM processes is obtained by the deposition of a large number of thin layers of material, e.g., about 1 micron in thickness. As an example, 250 layers of material might be required to form a micro-channel coating that is only about 0.01 inch (250 microns) in thickness. Moreover, the shape of channels formed by a DMLM process usually must be in an open format, since the channel is built from the bottom, upward.

New techniques or improvements in current techniques for fabricating cooling channels—especially micro-channels—continue to be of great interest. Additional processes that are capable of forming the channels directly on top of a substrate would be very attractive—especially if they can also eliminate or minimize the need for machining/filling processes. The new techniques should be capable of efficiently applying dense coating layers according to very precise dimensions and, perhaps, with fewer coating “passes” than are required by other techniques for a given thickness.

### BRIEF DESCRIPTION OF THE INVENTION

One embodiment of the invention is directed to a method for the formation of channels on a metallic substrate, comprising the steps of:
a) applying at least one layer of a metallic coating material onto a surface of the substrate by a cold spray technique, so as to define boundary walls for the channels, and to build the boundary walls to a desired height; and
b) applying additional coating material on one or more surfaces of the boundary walls by the cold spray technique, so as to modify the shape of the channels.

The substrate can be any type of high-temperature component or hot gas path component. In some instances, the substrate is a gas turbine engine wall, or a film-cooled airfoil or airfoil region of the engine, configured with one or more cooling passageways.

### BRIEF DESCRIPTION OF THE DRAWINGS

FIG. 1 is a simplified illustration of a cold spray system.

FIG. 2 is a depiction of a substrate on which cooling channels are being formed.

FIG. 3 is a depiction of a substrate, with continuing construction of cooling channels.

FIG. 4 is a depiction of a substrate, on which completed cooling channels are disposed.

FIG. 5 is a depiction of a substrate, on which cooling channels have been formed.

FIG. 6 is a depiction of a substrate, in which partial channels have been formed.

FIG. 7 is a depiction of the substrate of FIG. 6, after formation of at least one full channel.

### DETAILED DESCRIPTION OF THE INVENTION

When introducing elements of various embodiments of the present invention, the articles “a,” “an,” “the,” and “said” are intended to mean that there are one or more of the elements, unless otherwise indicated. Moreover, the terms “comprising,” “including,” and “having” are intended to be inclusive, and mean that there may be additional elements other than the listed elements. As used herein, the term “and/or” includes any and all combinations of one or more of the associated listed items. Furthermore, unless otherwise indicated herein, the terms “disposed on”, “deposited on” or “disposed between” refer to both direct contact between layers, objects, and the like, or indirect contact, e.g., having intervening layers therebetween.

Approximating language, as used herein throughout the specification and claims, may be applied to modify any quantitative representation that could permissibly vary without resulting in a change in the basic function to which it may be related. Accordingly, a value modified by a term such as “about” is not limited to the precise value specified. In some instances, the approximating language may correspond to the precision of an instrument for measuring the value.

Any substrate which is exposed to high temperatures and requires cooling can be used for this invention. Examples include ceramics or metal-based materials. Non-limiting examples of the metals or metal alloys which might form the substrate include steel, aluminum, titanium; refractory metals such as molybdenum; and superalloys, such as those based on nickel, cobalt, or iron. The substrate can also be formed of a composite material, such as a niobium silicide intermetallic composite. Very often, the substrate is at least one wall or other surface of a gas turbine engine component, e.g., a gas turbine blade.

For some of the embodiments of this invention, multiple layers of a metallic coating material are first applied onto the substrate surface, so as to define boundary walls for the channels that are being formed. The material forming the coating material can vary considerably, as long as it is compatible with the high temperature applications described herein. Very often, the material is a metal-aluminide (e.g., nickel aluminide or platinum aluminide). In other cases, the material can formed of an MCrAlX composition, where “M” can be iron, nickel, cobalt, or combinations thereof; and X can be yttrium, Y, Ta, Si, Hf, Ti, Zr, B, C, or combinations thereof. Non-limiting examples of some of these materials can be found in a variety of references, such as U.S. Pat. No. 6,234,755, incorporated herein by reference.

The present invention generally relates to cooling channels for high temperature substrates. While “channels” will be used in this disclosure for simplicity, the preferred types of small channels for many types of end uses are more commonly known as “micro-channels”. For industrial-sized power generating turbine components, “small” or “micro” channel dimensions would encompass approximate depths and widths in the range of about 0.25 mm to about 1.5 mm. For aviation-sized turbine components, channel dimensions would encompass approximate depths and widths in the range of about 0.1 mm to about 0.5 mm. A cooling fluid may be provided to the channels from a plenum, and the cooling fluid may flow through the channels, cooling the hot gas path component.

In some very preferred embodiments, a cold spray technique is used to apply the layers of metallic coating material onto the substrate surface, to begin forming the channels. Cold spray techniques are known in the art, and described in various references, such as “Current Trends in Cold Spray Technology: Looking at the Future”; Julio Villafuerte, Centerline Windsor, Ltd., Jan. 8, 2010 (www.metalfinishing.com), incorporated herein by reference. Other references include U.S. Patent Publications 2013/0177437 (Amancherla et al), published Jul. 11, 2013; and 2013/0153089 (Ajdelsztajn et al), published Jun. 20, 2013, both of which are incorporated herein by reference. In very general terms, “cold spray” is a solid-state coating process, i.e., the particles do not melt during the process. Cold spraying uses a high-speed gas jet to accelerate the metallic powder particles toward a substrate, whereby the particles plastically deform and consolidate upon impact.

As described in Ajdelsztajn et al (noted above), typical cold spray techniques employ a spray gun that receives a high pressure gas, such as helium, nitrogen, or air, along with a feedstock of deposit material, e.g., metals, alloys, or composite materials, in powder form. The powder granules are introduced at a high pressure into a gas stream in the spray gun, and emitted from an appropriate nozzle. The particles are accelerated to a high velocity in the gas stream. They may in fact reach a supersonic velocity. The gas stream may be heated. Typically, the gases are heated to less than the melting point of the particles, so as to minimize in-flight oxidation and phase changes in the deposited material. In some embodiments, the carrier gas is maintained at a temperature in the range of about 20° C. to about 1200° C.

Although the inventors do not wish to be bound by a specific theory, it is thought that the heat generated during the cold spray process is a key factor in the onset of adiabatic shear instability in the particles. This in turn plays a key role in being able to economically apply dense coating layers.

In general, in the cold spray process, an impact critical velocity of the feedstock material is defined as a velocity below which the particle adhesion to the substrate is not useful for the intended application. The critical velocity of the feedstock material may depend on the identity of the feedstock particles, and the type of substrate present. In some embodiments, the velocity of the feedstock during cold-spraying is in the range from about 500 m/s to about 1100 m/s.

As a result of the relatively low deposition temperatures and very high velocities, the cold spray process is especially suited for applying a well-adhering, metallurgically bonded, dense coating. Moreover, when controlled by a computer, as described below, the cold spray technique is capable of controllably and precisely applying strips of the metallic coating to a selected surface. These strips define the boundary walls of the channels on the substrate.

The purity of the coating formed on the substrate depends in part on the purity of the powdered feedstock that is used. The powder impacts the substrate at a high velocity. The kinetic energy of the powder causes the powder granules to deform and flatten on impact with the substrate. The flattening promotes a metallurgical or mechanical bond with the substrate, or a combination of metallurgical and mechanical bonding. A distinct advantage of cold spraying techniques is the negligible, or very minimal, phase change or oxidation of particles during their flight to the substrate.

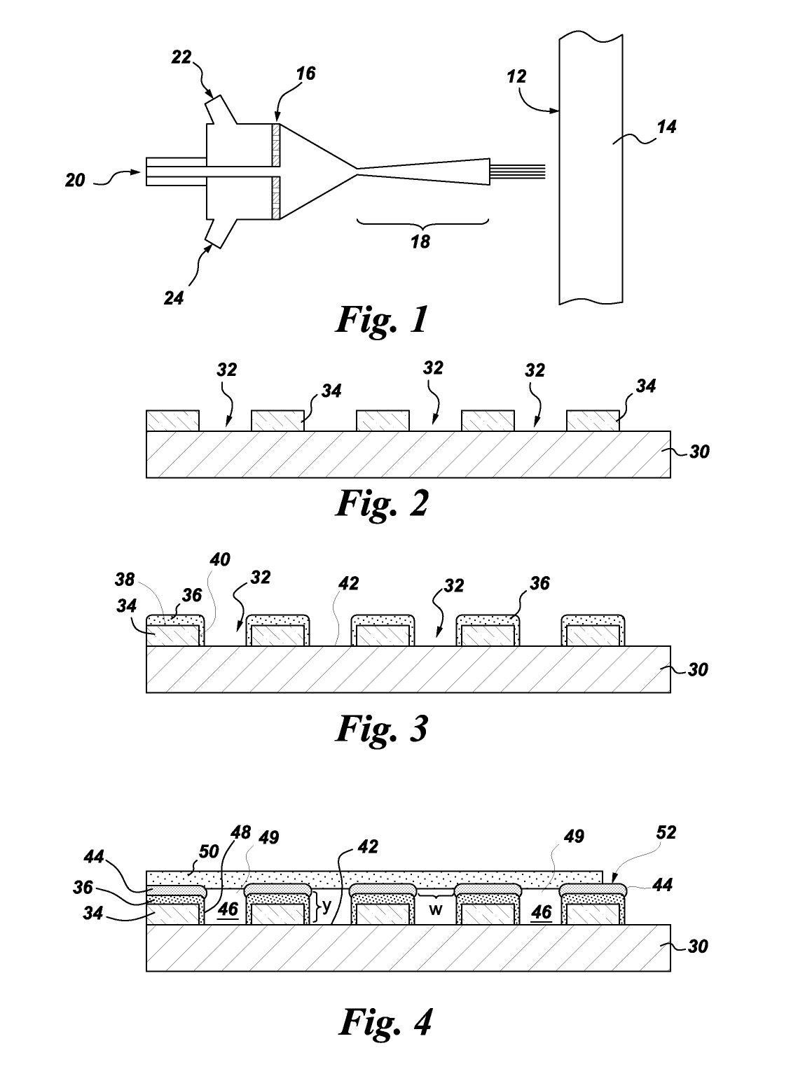

FIG. 1 is a view of an exemplary cold spraying system 10, for depositing a powder coating material onto a surface 12 of a substrate 14. The surface 12 can represent a gas turbine engine wall. The system 10 includes a spray gun 16, typically equipped with a converging/diverging nozzle 18, through which the powdered coating material is sprayed onto the surface. The substrate 14 may be formed from any suitable material known in the art, as described previously. During the coating process, the substrate 14 may be held stationary, or may be articulated, rotated, or translated by any suitable means (not shown) known in the art.

With continued reference to FIG. 1, the powder coating material is fed into the spray gun 16, via any suitable powder inlet 20. In some specific embodiments, the particles of the powdered coating materials are accelerated to supersonic velocities, using compressed gas. The gas can be fed to the spray gun 16 via gas inlet 22. The gas forces the powder onto the substrate at speeds that are typically in a range of between 800 meters per second (m/s) to 1500 m/s. As alluded to previously, the high-speed delivery causes the powder to adhere to the substrate surface, and form a hard layer thereon. It should be understood that delivery speeds can vary to levels below about 800 m/s and above about 1500 m/s, and more preferably, between about 800 m/s and 1200 m/s, depending on the desired adhesion characteristics and powder type.

The spray gun 16 can further include a sensor receiver 24 for supporting temperature and/or pressure sensors configured to monitor parameters of the process gas. When applying the powdered coating materials to form the layer(s) on the substrate surface, the spray gun nozzle 18 can be held at a distance from the surface 12, known as the standoff distance. In one embodiment, the standoff distance is about 10 millimeters (mm) to about 100 mm.

Generally, the cold spraying process parameters are adjusted to achieve a hard coating layer with a fine grained structure. A key advantage of using cold spray for this process is that, since the particles are maintained below their melting point, their characteristics are not affected by any “thermal history”. Therefore, the microstructure of the coating layer is substantially identical to the microstructure of the original coating particles. As alluded to previously, the fine microstructure helps to ensure a higher strength deposit on the substrate surface.

It should also be understood that various types of cold spray processes are available in the art, and can be used and/or modified to carry out the present invention. The “Metalfinishing” reference listed above (J. Villafuerte), for example, describes both a high pressure and a low pressure type of cold spray. In the high-pressure technique, the coating powder is injected into the system at a location before the spray nozzle throat, from a high pressure gas supply. In the low-pressure technique, the powder is injected into the diverging section of the spray nozzle, from a low-pressure gas supply. Those skilled in the cold-spraying art will be familiar with details that allow either process to be used for the present invention, when reviewed in conjunction with the teachings herein.

As mentioned previously, multiple layers of the coating material, e.g., an aluminide material, are applied to the substrate, so as to define boundary walls. A substrate 30 is depicted in FIG. 2. The general regions planned for the channels are depicted as features 32. The regions are effectively formed by the deposition of strip layers 34, by the cold spray process described above. Each layer or strip 34 can be applied very precisely, depending on the preselected dimensions for the channel regions 32.

Moreover, layers 34 may be applied in the form of multiple, cold-sprayed sub-layers, e.g., each sub-layer having, for example, a general height that is about 10% to about 50% of the overall height of the layer. As one specific illustration, layer 34 can have an overall thickness of about 1 mil (25 microns) to about 100 mils (2.5 mm). A 40 mil (1.02 mm) layer could be formed by the deposition of about 10 to 100 individual layers of the coating material, although the deposition regimen can vary considerably.

Embodiments of the cold spray process employed herein are advantageous, in that the coating layers can efficiently be applied to the underlying surface in precise shapes and thicknesses. Some of the other conventional techniques available in the art, e.g., specialized versions of the DMLM process, may be able to obtain a similar level of precision, in terms of layer size and shape. However, those techniques may require an extreme number of coating “passes” to do so, which would generally be impractical for some of the specific end uses contemplated for the present invention.

As shown in FIG. 3, additional coating material 36 is then applied, overlapping at least a portion of the strip layers. Thus, the additional material is applied on one or more surfaces of the boundary wall formed in the previous step, e.g., top surface 38, or the interior side surface 40. (As used herein, the “interior surface” is meant to refer to the general surface that will constitute the sidewall of a channel). As shown in the figure, the coating material 36 can also be deposited on a portion of an upper surface 42 of the substrate, although this is not always necessary, and will depend on the desired shape for the channels.

As mentioned previously, the additional coating material is applied according to a pattern that defines the boundary walls of each channel. The layers can be deposited in a precise manner by computer-controlling the deposition process. For example, those skilled in the art understand that a spray system can include or be attached to a multi-axis computer numerically controlled (CNC) unit, or similar devices that operate on that principle. The CNC systems themselves are known in the art, and allow movement of the spray gun along a number of X, Y, and Z axes, as well as rotational axes. The cold spray nozzle could be very precisely moved in a direction perpendicular to the plane of FIG. 3, for example, to build up each coating layer.

As shown in FIG. 4, the deposition can continue as upper layers 44 are applied, to further define the shape of the cooling channels 46 (which began as channel regions 32). While the upper layers may primarily be deposited over the generally-horizontal surface of the previously-applied layers, they can also overlap the generally vertical region of the lower layer, e.g., surface 48 of layer 36. The exact shape of the upper layer(s) can vary considerably, and will depend in part on the desired shape of the cooling channel.

Coating layers 34, 36 and 44 can be thought of as “boundary walls” for the channels. The pattern of deposition of the coating layers 34, 36, and 44 in FIG. 4 is determined in part by the desired sidewall profile “Y” for the channel(s) 46. The profile may be vertical, relative to surface 42, or may be slanted, greater or less than 90 degrees relative to the horizontal surface. The profile Y can also be irregular, e.g., with a bulge (from layer 44) into the channel 46. As alluded to previously, the exact profile will depend in part on the cooling requirements needed for the particular substrate and component in which the channels are incorporated.

Moreover, the shape of the applied layers of coating material is also influenced by the amount of bridging needed to close off the channel in its upper region, i.e., region 49 in FIG. 4. As described below, a top layer 50 can be applied over all of the channels 46, so as to seal them and enable them to function as conduits for a coolant fluid. The support needed for the top layer will depend in part on its composition, as well as on the composition of the various coating layers, and the specific deposition conditions under which they are applied. Thus, the upper width “w” of each channel will be determined by the selected dimensions of layer 44, based in part on the amount of bridging needed for top layer 50.

At least one top layer 50 is applied over a top surface 52 of the boundary walls (in FIG. 4, specifically, on top of layer 44). The top layer functions to close the upper openings of the channels. The top layer can be formed of a suitable metallic material like MCrAlX (described above), or it can be formed from a different composition. Moreover, the top layer need not be applied by a cold spray technique, and could instead be applied by other thermal spray processes, as described below for specific embodiments. The thickness of the top layer can vary, and will depend in part on factors like the overall integrity required for the channel-coating system. Usually, the top layer has a thickness in the range of about 10% to 50% of the depth of channel 46.

A metallic top layer could then be covered with a ceramic material (i.e., an overlayer, not shown in the figures). For example, the ceramic layer can be a yttria-stabilized zirconia material, functioning as a thermal barrier coating (TBC) for the substrate. Those skilled in the art are familiar with coating processes for applying TBC's.

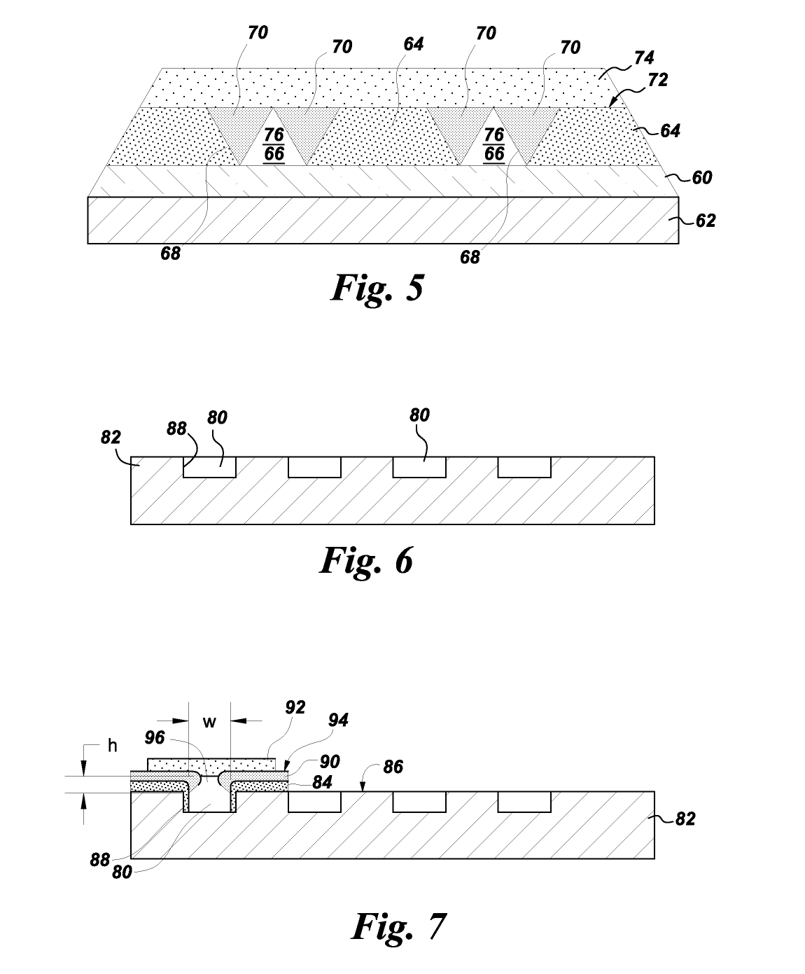

Another embodiment for the formation of channels on a substrate is depicted in FIG. 5. In this embodiment, at least one base layer 60 is first applied over substrate 62. The base layer can also be an aluminide or MCrAlX material, for example. The presence of the base layer can be helpful at times, e.g., in providing a smoother, more consistent “platform” for the subsequently applied layers. Base layer 60 is usually also applied by a cold spray technique, although other deposition methods are possible for this layer. The thickness of the base layer will depend on various factors, such as the contour and/or roughness of the substrate; and the specific composition of the base layer. In the case of turbine blades in which microchannels will be incorporated, the thickness of the base layer is usually about 10% to about 50% of the depth of the channel that will be formed over the layer, as described below.

At least one layer 64 is then applied over the base layer 60, by way of the cold spray technique described above. In the manner described above, layer(s) 64 can be deposited according to a pattern consistent with a desired boundary wall for a prospective channel 66, as shown in FIG. 5. In this non-limiting illustration, the boundary walls 68 are angled or slanted inwardly toward the channel region.

One or more additional coating layers 70 can then be applied by the cold spray technique. The additional layers further define the shape of the channels 66, building up the walls that eventually merge to close the channels. As in the case of coating layers 64, layers 70 can be applied according to a pattern that will provide the desired interior shape of channels 66, i.e., they depend on the “build-up” plan for the overall structure.

In these embodiments, at least one top layer 74 can be applied over at least a portion of upper surface 72. In some specific embodiments, the top layer (or multiple layers) is applied over the entire, underlying surface (i.e., layers and openings), so as to cover the layers and also close the upper openings 76 of the channels 66.

In some cases, the top layer 74 can also be a metallic coating, e.g., aluminide or MCrAlX, as in the layers below it. The coating can be deposited by the cold spray technique described above, in many preferred embodiments. However, in other situations, another coating technique might be employed. For example, a thermal spray process is possible, such as high velocity oxygen fuel spraying (HVOF) or high velocity air fuel spraying (HVAF). Plasma spray processes can also be used to apply the coating. Examples include atmospheric (such as air or inert gas) plasma spray, low pressure plasma spray (LPPS), or vacuum plasma spray (VPS). Other illustrative techniques for depositing the structural coating include, without limitation, sputtering, electron beam physical vapor deposition, electroless plating, and electroplating. In some instances, the metallic coating can be compositionally graded. Moreover, as described previously for other embodiments, the top layer could comprise a metallic layer, covered by a ceramic coating, e.g., a zirconia-based TBC.

Another embodiment of the invention is directed to a method of forming or modifying channels, where partial channels are already in place, and the new boundary walls of the channels become an extension of the existing channels, i.e., the channel walls. With reference to FIG. 6, partial channels 80 can be formed in a substrate 82 by a number of conventional methods, e.g., machining, casting, abrasive liquid jet, electrode discharge machining (EDM), and the like. The dimensions of the channels will depend on the circumstances in which they were formed on the substrate.

At least one layer 84 of metallic coating material can then be applied to an upper surface 86 of the substrate, using the cold spray technique described previously, as shown in FIG. 7 (The figure illustrates the layer build-up over only one channel, for simplicity). Layer 84 (in the form of a single layer or multiple layers) is shown to overlap the wall of the channel, i.e., being applied over surface 86 and channel side surface 88.

Following the deposition of layer 84 (in the form of a single layer or multiple layers), at least one additional layer 90 can be applied over layer 84, overlapping the first layer, as shown in FIG. 7. In this manner, the desired height “H”, width “W”, and overall shape of the channel can be obtained. At least one top layer 92 can then be applied over an upper surface 94 of the underlying layer, bridging the channel walls and effectively sealing the channel 96. As mentioned above, the top layer can be metallic or ceramic, and can be applied by a cold spray technique or by other processes. The use of the techniques described herein, on partially-formed channels, could be very useful for repairing, reconditioning, or modifying cooling channels in high temperature components like gas turbine blades.

Various embodiments of this invention have been described in rather full detail. However, it should be understood that such detail need not be strictly adhered to, and that various changes and modifications may suggest themselves to one skilled in the art, all falling within the scope of the invention as defined by the appended claims.

What is claimed:

1. A method for the formation of channels on a metallic substrate, comprising the steps of:
a) applying at least one layer of a metallic coating material onto a surface of the substrate by a cold spray technique, so as to define boundary walls for the channels, and to build the boundary walls to a desired height; and
b) applying additional coating material on one or more surfaces of the boundary walls by the cold spray technique, so as to modify the shape of the channels.

2. The method of claim 1, wherein the cold-spray technique is carried out at a temperature that is less than the melting point of the coating material.

3. The method of claim 1, wherein the coating material comprises a metal aluminide or an MCrAl(X) composition, where M is iron, nickel, cobalt, or mixtures thereof; and X is Y, Ta, Si, Hf, Ti, Zr, B, C, or combinations thereof.

4. The method of claim 1, wherein the average depth of the channels is in the range of about 0.1 mm to about 1.5 mm.

5. The method of claim 1, wherein, for each boundary wall, the additional coating material is applied to overlap a previously-applied layer.

6. The method of claim 1, wherein the coating material layers are applied according to a deposition pattern that results in slanted boundary walls.

7. The method of claim 1, wherein step (a) is preceded by the deposition of at least one base layer over the substrate of the surface, so that the channels are formed on the base layer.

8. The method of claim 1, wherein at least one top layer is applied over a top surface of the boundary walls and the channels, thereby closing upper openings of the channels.

9. The method of claim 8, wherein the top layer is applied by a thermal spray process, or by a cold spray process.

10. The method of claim 9, wherein the thermal spray process is a combustion spray process or a plasma spray process.

11. The method of claim 8, wherein the top layer is a metal aluminide or an MCrAl(X) composition, where M is iron, nickel, cobalt, or mixtures thereof; and X is Y, Ta, Si, Hf, Ti, Zr, B, C, or combinations thereof.

12. The method of claim 11, wherein a ceramic layer is applied over the top layer.

13. The method of claim 12, wherein the ceramic layer is a chemically-stabilized zirconia material capable of functioning as a thermal barrier coating.

14. The method of claim 1, wherein the substrate is a gas turbine engine wall.

15. The method of claim 1, wherein the substrate is a film-cooled airfoil or airfoil region of a gas turbine engine, configured with one or more cooling passageways.

16. The method of claim 1, wherein the boundary walls of the channels are an extension of channel walls for a pre-existing channel formed within the substrate.

17. A method for the formation of channels on the surface of a gas turbine engine component, comprising the step of applying multiple, overlapping layers of a metallic coating material onto a surface of the substrate by a cold spray technique, so as to define boundary walls for the channels, and to build the boundary walls to a desired height and channel size.
